(19) United States
(12) Patent Application Publication
(10) Pub. No.: US 2006/0077247 A1
(43) Pub. Date: Apr. 13, 2006

(54) Inkjet recording material, printing matter laminate using it and production method for printing matter pasting element

(75) Inventors: Toshiya Kobayashi, Chofu-shi (JP); Hirotaka Tubaki, Kawasaki (JP); Kouji Nii, Uenohara-shi (JP); Takahiko Nishikawa, Saitama-shi (JP)

Correspondence Address: BIRCH STEWART KOLASCH & BIRCH, PO BOX 747, FALLS CHURCH, VA, 22040-0747, US

(73) Assignee: ZEON KASEI CO., LTD., Tokyo (JP)

(21) Appl. No.: 10/550,708

(22) PCT Filed: Mar. 30, 2004
(86) PCT No.: PCT/JP04/04563

§ 371 Date: Sep. 26, 2005

(30) Foreign Application Priority Data
Mar. 31, 2003 (JP) 2003-093103
Aug. 14, 2003 (JP) 2003-293332

(51) Int. Cl. B41J 2/01

(52) U.S. Cl. 347/105

(57) ABSTRACT

A material for inkjet recording which can be printed by the inkjet recording method using a pigment-based ink of the nonaqueous type obtained by dispersing pigments in a nonaqueous medium containing a glycol ether as the main component, exhibits excellent properties of drying, fixing and printing the ink and excellent weatherability and provides a printed image of excellent quality with remarkable clarity without formation of cracks; a laminate having a print which has an inkjet recorded material having a printed image of excellent quality formed on the face of the material for inkjet recording by the inkjet recording method and a member for attachment laminated to the face having the printed image of the inkjet recorded material; and a process for producing an article attached with a print in which the laminate having a print is attached to an adherend.

### TECHNICAL FIELD

The present invention relates to a material for inkjet recording, a laminate having a print obtained by using the material and a process for producing an article attached with a print. More particularly, the present invention relates to a material for inkjet recording which can be printed by the inkjet recording method using a pigment-based ink of the nonaqueous type obtained by dispersing pigments in a nonaqueous medium containing a glycol ether as the main component, exhibits excellent properties of drying, fixing and printing the ink and excellent weatherability and provides a printed image of excellent quality with remarkable clarity without formation of cracks.

The present invention also relates to a laminate having a print which has an inkjet recorded material having a printed image of excellent quality formed on the face of the material for inkjet recording by the inkjet recording method and a member for attachment laminated to the face having the printed image of the inkjet recorded material; and a process for producing an article attached with a print which comprises attaching the laminate having a print to an adherend.

### BACKGROUND ART

Recently, as the technology utilizing computers is widely employed, posters and materials for presentation are frequently printed out easily based on materials and images prepared by using computers. As the printer, dot impact printers, laser printers, thermal printers and inkjet printers are used. Among these printers, the inkjet printers are widely used due to the advantages in that mechanical noise during the printing is low, full color printing can be made, and the running cost of printing is small.

In the inkjet printers, minute droplets of ink are injected at a great speed from a nozzle to a sheet for recording, and images and characters are recorded with the droplets of ink attached to the recording face.

In the inkjet recording method described above, dye-based inks of the aqueous type containing dyes as the coloring agents have been mainly used.

However, since the inkjet recording is recently used for outdoor posters, displays and advertisement boards having a great size, the use of pigment-based inkjet inks of the nonaqueous type using pigments as the coloring agents are increasing so that printed images excellent with respect to weatherability, fixing of ink, water resistance, gloss and reproduction of the image can be obtained.

However, in general, the ink receiving layer in materials for inkjet recording is a layer suited for dye-based inks of the aqueous type such as a layer containing macromolecular compounds soluble in water and a hydrophilic layer. When a pigment-based ink of the nonaqueous type is used, the pigments are not absorbed into the ink receiving layer and remain in a condition such that the pigments are simply placed on the ink receiving layer. Drawbacks arise due to this condition in that the property for fixing the ink is poor, and problems such as elimination of the printed image by friction and attachment of the ink to other articles arise, and that water resistance and weatherability are insufficient.

To overcome the above problems, as the material for recording which is suitable for printing with a pigment-based ink of the non-aqueous type containing glycol ethers as the main media, for example, a material for recording having an ink-absorbing layer comprising a specific cellulose acetate butyrate is proposed (Japanese Patent Application Laid-Open No. 2002-219864). In accordance with the above publication, the above material for recording is excellent with respect to the property of drying the ink, gloss of the formed printed image and reproducibility of the image and is sufficiently durable for the outdoor use without lamination of plastic films.

However, it is shown by the examination by the present inventors that the above material for inkjet recording occasionally exhibits a poor property of drying a printed image, and cracks are occasionally formed in the printed image. These problems arise markedly when acrylic resins are used as the base material in place of vinyl chloride resins due to the environmental problems.

Recently, printers can be used in the high speed printing mode, and the printing can be performed at a speed twice that of the ordinary printing. In this case, cracks tend to be formed, and a means for overcoming this problem has been desired.

### DISCLOSURE OF THE INVENTION

Under the above circumstances, the present invention has a first object of providing a material for inkjet recording which can be printed by the inkjet recording method using a pigment-based ink of the nonaqueous type obtained by dispersing pigments in a nonaqueous solvent containing a glycol ether as the main component, exhibits excellent properties of drying, fixing and printing the ink and excellent weatherability and provides a printed image of excellent quality with remarkable clarity without formation of cracks and furthermore, can be applicable to high-speed printing.

The present invention has a second object of providing a laminate having a print which has an inkjet recorded material having a printed image of excellent quality formed on the face of the material for inkjet recording by the inkjet recording method and a member for attachment laminated to the face having the printed image of the inkjet recorded material; and a third object of providing a process for producing an article attached with a print comprising attaching the laminate having a print to an adherend.

As the result of intensive studies by the present inventors to achieve the above objects, it was found that the first object could be achieved by a material for inkjet recording comprising a base material and an intermediate layer comprising a specific resin and an ink receiving layer comprising a cellulose ester and a plasticizer in specific relative amounts, which are disposed successively on one face of the base material.

It was found that the second object could be achieved by a laminate having a print which comprises an inkjet recorded material obtained from the material for inkjet recording by forming the print on the face of the ink receiving layer by the inkjet recording method preferably using a pigment-based ink of the nonaqueous type, and a member for attachment comprising a support which is laminated to the face having the print of the ink receiving layer of the inkjet recorded material and has an adhesive layer having a release sheet; and that the third object could be achieved by a process comprising removing the release sheet from the laminate having a print, bringing the exposed adhesive layer into contact with an adherend, and attaching the print in the laminate having a print to the adherend to obtain an article attached with the print.

The present invention has been completed based on, the above knowledge.

The present invention provides:

(1) A material for inkjet recording which comprises a base material, an intermediate layer comprising at least one of a vinyl halide resin and/or a vinyl halide/(meth)acrylate copolymer resin and an ink receiving layer comprising a cellulose ester and 10 to 100 parts by weight of a plasticizer per 100 parts by weight of the cellulose ester, the intermediate layer and the ink receiving layer being disposed successively on one face of the base material;

(2) A material for inkjet recording described in (1), wherein the cellulose ester in the ink receiving layer is at least one substance selected from cellulose acetate butyrate, cellulose acetate propionate and cellulose acetate;

(3) A material for inkjet recording described in any one of (1) and (2), wherein the plasticizer in the ink receiving layer is a phthalate-based plasticizer;

(4) A material for inkjet recording described in any one of (1) to (3), wherein the base material is a base material comprising an acrylic resin as a raw material;

(5) A material for inkjet recording described in any one of (1) to (4), wherein a thickness of the ink receiving layer is 5 to 70 μm;

(6) A material for inkjet recording described in any one of (1) to (5), wherein a content of the plasticizer in the ink receiving layer is 20 to 80 parts by weight per 100 parts by weight of the cellulose ester;

(7) A laminate having a print which comprises inkjet recorded material (A) which is a material for inkjet recording described in any one of (1) to (6) and comprises a transparent base material and an ink receiving layer having the print on a face, and member for attachment (B) comprising a support which is laminated to the face having the print of the ink receiving layer of inkjet recorded material (A) via an adhesive layer and has an adhesive layer having a release sheet and disposed on a face opposite to the face attached to inkjet recorded material (A);

(8) A laminate having a print described in (7), wherein the support in member for attachment (B) is a support obtained from an acrylic resin as a raw material;

(9) A laminate having a print described in any one of (7) and (8), wherein inkjet recorded material (A) comprises a protective film disposed on a face of the base material opposite to a face having the ink receiving layer;

(10) A process for producing an article attached with a print, which comprises removing a release sheet from a laminate having a print described in any one of (7) and (8), bringing an exposed adhesive layer into contact with an adherend, and pressing the laminate having a print at a side of the base material of inkjet recorded material (A) so that the print on the laminate is attached to the adherend; and

(11) A process for producing an article attached with a print, which comprises removing a release sheet from a laminate having a print described in (9), bringing an exposed adhesive layer into contact with an adherend, pressing the laminate having a print at a side of the protective film so that the print on the laminate is attached to the adherend, and removing the protective film.

### BRIEF DESCRIPTION OF THE DRAWINGS

FIG. 1 shows a sectional view of an embodiment of the laminate having a print of the present invention. The numbers in FIG. 1 have the following meanings: 1: a base material; 2: an intermediate layer; 3: an ink receiving layer; 4: a layer having a print; 5: adhesive layer I; 6: a support; 7: adhesive layer II; 8: a release sheet; 9: a protective film; 10: an inkjet recorded material; 20: a member for attachment; 30: a laminate having a print; and 40: a material having a print.

### THE MOST PREFERRED EMBODIMENT TO CARRY OUT THE INVENTION

The material for inkjet recording of the present invention will be described in the following.

The material for inkjet recording comprises a base material and an intermediate layer and an ink receiving layer which are disposed successively on one face of the base material.

The base material of the material for inkjet recording is not particularly limited as long as the base material has the mechanical properties suitable as the base material. Examples of the substances advantageously used as the base material include films, sheets and plate shaped materials comprising polyester resins such as polyethylene terephthalate, polybutylene terephthalate and polyethylene naphthalate; acrylic resins such as poly(methyl methacrylate); polyolefin resins such as polyethylene, polypropylene, ethylene/propylene copolymers and polymethylpentene; celluloses such as cellophane, diacetylcellulose, triacetylcellulose and acetylcellulose butyrate; polyvinyl chloride-based resins; polyvinylidene chloride-based resins; polyvinyl alcohol-based resins; ethylene-vinyl acetate copolymer-based resins; polystyrene-based resins; polysulfone-based resins; polyether ether ketone-based resins; polyether sulfone-based resins; polyether imide-based resins; polyimide-based resins; fluororesins; polyamide-based resins; and polycarbonate-based resins; paper base materials such as wood free paper, wood-containing paper, art paper, bonded paper, regenerated paper, baryta paper, coated paper and corrugated cardboards; fabrics such as mixed spun or mixed woven fabrics and non-woven fabrics using natural fibers, synthetic fibers, regenerated fibers and semi-synthetic fibers singly or in combination of two or more; and composites of these materials. Among the above base materials, films, sheets and plate shaped materials comprising synthetic resins are preferable, and films and sheets comprising polyethylene terephthalate, polypropylene, polycarbonates, vinyl halide-based resins such as polyvinyl chloride resins and acrylic resins as the raw material are more preferable.

The material for inkjet recording of the present invention has the characteristic in that the specific intermediate layer is disposed between the base material and the ink receiving layer. The effect of the intermediate layer is remarkably exhibited when a film or a sheet obtained from an acrylic resin as the raw material is used as the base material.

The film and the sheet obtained from an acrylic resin as the raw material is not particularly limited. For example, films and sheets comprising polymethacrylates such as poly(methyl methacrylate) and poly(ethyl methacrylate), conventional copolymers of acrylates and methacrylates with synthetic rubbers, copolymers of acrylic esters, methacrylates and styrene, and acryl urethane-based resins in which an acryl polyol is crosslinked with a polyisocyanate crosslinking agent, are preferable.

The above base material may have a single layer structure or a laminate structure. The base material may be transparent, translucent or opaque. Transparent or translucent base materials are preferable. The base material may be colored or not colored, and can be suitably selected in accordance with the application.

When a resin is used for the base material, stabilizers such as photostabilizers, ultraviolet light absorbents and antioxidants may be added, where necessary. One face or both faces of the base material may be subjected to a surface treatment such as the oxidation treatment and the roughening treatment to enhance adhesion with the layer disposed on the surface, where desired. Examples of the oxidation treatment include the treatment by corona discharge, the treatment with plasma, the treatment with chromic acid (a wet process), the treatment with flame or heated air and the treatment with ozone under irradiation with ultraviolet light. Examples of the roughening treatment include the sand blasting and the treatment with a solvent. The surface treatment can be suitably selected in accordance with the type of the base material. In general, the treatment by corona discharge is preferable from the standpoint of the effect and the operability. The base material may be treated with a primer.

As the base material, various types of commercial films and sheets can be used. The base material may be formed by coating a film of poly(ethylene terephthalate) used as the process sheet with a composition for constituting the base material, followed by drying the coating composition.

The thickness of the base material is not particularly limited. The thickness is, in general, 10 to 200 μm and preferably 30 to 100 μm.

In the material for inkjet recording of the present invention, the intermediate layer disposed between the base material and the ink receiving layer is a layer comprising a vinyl halide resin and/or a vinyl halide/(meth)acrylate copolymer resin.

The above vinyl halide resin is not particularly limited as long as the resin is a homopolymer resin or a copolymer resin of a vinyl halide such as vinyl chloride, vinyl fluoride, vinylidene chloride and vinylidene fluoride. The vinyl chloride resin and the vinylidene chloride resin are preferable.

The vinyl halide/(meth)acrylate copolymer resin is a copolymer resin of a vinyl halide and a (meth)acrylate. As the vinyl halide, vinyl chloride, vinyl fluoride, vinylidene chloride and vinylidene fluoride can be used. In the present invention, the (meth)acrylate means an acrylate and/or a methacrylate.

The (meth)acrylate to obtain the vinyl halide/(meth)acrylate copolymer resin is not particularly limited. Examples of the (meth)acrylate include methyl methacrylate, ethyl methacrylate, methyl acrylate and ethyl acrylate. It is preferable that the content of the monomer unit of the vinyl halide in the vinyl halide/(meth)acrylate copolymer resin is 25% by weight or greater.

The vinyl halide resin and the vinyl halide/(meth)acrylate copolymer resin may further comprise units of monomers copolymerizable with the vinyl halide or the (meth)acrylate such as ethylene, vinyl acetate and styrene as long as the effect of the present invention is not adversely affected.

The molecular weight of the vinyl halide resin and the vinyl halide/(meth)acrylate copolymer resin used in the present invention is not particularly limited.

The vinyl halide resin and the vinyl halide/(meth)acrylate copolymer resin may be used singly or in combination of two or more. An acrylic resin may be added to the vinyl halide resin or the vinyl halide/(meth)acrylate copolymer resin. In this case, the formation of cracks on the printed image can be effectively prevented when the total of the content of the acrylic resin and the content of the unit of the (meth)acrylate in the vinyl halide/(meth)acrylate copolymer resin is 75% by weight or smaller of the entire amount of the intermediate layer.

The intermediate layer is formed by homogeneously dissolving the vinyl halide resin and/or the vinyl halide/(meth)acrylate copolymer resin and the acrylic resins which is used where desired into a suitable organic solvent, followed by adjusting the concentration, applying the obtained coating fluid to the base material and drying the formed coating layer.

It is preferable that the thickness of the intermediate layer is 1 to 50 μm and more preferably 3 to 25 μm after being dried.

The organic solvent is not particularly limited as long as the vinyl halide resin and the vinyl halide/(meth)acrylate copolymer resin described above can be homogeneously dissolved. Examples of the solvent include ketone solvents such as methyl ethyl ketone, ester solvents such as ethyl acetate, and aromatic hydrocarbon solvents such as toluene.

The application of the above coating fluid to the base material can be conducted using a conventional means such as a film applicator, a gravure roll coater, a reverse roll coater, an air knife coater, a bar coater, a blade coater, a spray coater and a curtain coater.

The condition of drying the applied coating fluid is not particularly limited as long as degradation of the base material and the intermediate layer does not take place.

The ink receiving layer disposed on the intermediate layer in the material for inkjet recording of the present invention is a layer comprising a cellulose ester and a plasticizer.

The cellulose ester is not particularly limited as long as the cellulose ester is an ester of cellulose and an organic acid. Examples of the cellulose ester include cellulose acetate (CA), cellulose acetate butyrate (CAB), cellulose acetate propionate (CAP) and esters of cellulose with aliphatic carboxylic acids such as caprylate and laurate of cellulose. Aromatic acid esters of cellulose such as benzoates and toluates of cellulose can also be used.

The number average molecular weight of the cellulose ester is different depending on the type of the cellulose ester. For example, it is preferable that the number average molecular weight of cellulose acetate (CA) is in the range of 30,000 to 60,000, the number average molecular weight of cellulose acetate butyrate (CAB) is in the range of 10,000 to 70,000, and the number average molecular weight of cellulose acetate propionate (CAP) is in the range of 10,000 to 80,000.

The degree of acetylation of the cellulose ester is different depending on the type of the cellulose ester. For example, it is preferable that the degree of acetylation of cellulose acetate (CA) is about 40% by mole, the degree of acetylation of cellulose acetate butyrate (CAB) is in the range of about 2 to 30% by mole, and the degree of acetylation of cellulose acetate propionate (CAP) is in the range of about 0.5 to 30% by mole. It is preferable that the degree of butyrylation of cellulose acetate butyrate (CAB) is in the range of 15 to 55% by mole, and the degree of propionylation of cellulose acetate propionate (CAP) is in the range of 40 to 50% by mole. It is preferable that the content of hydroxyl group in the cellulose ester is in the range of 1 to 5% by weight.

By adjusting the degree of esterification such as the degree of butyrylation in the above range, the property of receiving and drying the inkjet ink can be kept excellent, the formation of cracks in the formed printed image can be effectively prevented, and a clear image can be obtained.

It is preferable that the glass transition temperature of the cellulose ester is 80 to 170° C. and more preferably 100 to 150° C.

By adjusting the glass transition temperature in the above range, the property of receiving and drying the inkjet ink can be kept excellent, the formation of cracks in the formed printed image can be effectively prevented, and a clear image can be obtained.

The cellulose ester may be used singly or in combination of two or more.

It is necessary that the plasticizer be present in the ink receiving layer in an amount in the range of 10 to 100 parts by weight per 100 parts by weight of the cellulose ester described above.

By the presence of the plasticizer, the property of penetration of the ink can be improved, the property of drying and fixing the ink can also be improved, and the formation of cracks in the formed printed image can be prevented.

It is preferable that the amount of the plasticizer is 20 to 80 parts by weight and more preferably 30 to 60 parts by weight. When the amount is less than the above range, the effect is insufficient. When the amount exceeds the above range, there is the possibility that the problem of bleeding takes place.

When the printing is conducted at a high speed, it is preferable that the amount of the plasticizer is 50 to 60 parts by weight. When the amount of the plasticizer is in this range, the property of drying the ink is excellent and cracks are not formed in the formed printed image even when the speed of injection of the ink is great in the high speed printing. In the case of the “high speed printing”, the time of printing per unit area is about one half of that in the case of the standard printing, and the speed of injection of the ink is about twice that in the case of the standard printing.

The type of the plasticizer is not particularly limited. Examples of the plasticizer include phthalate-based plasticizers; phosphate-based plasticizers; adipate-based plasticizers; sebacate-based plasticizers; glycol derivative-based plasticizers such as diethylene glycol dibenzoate and dipropylene glycol dibenzoate; glycerol derivative-based plasticizers such as glycerol triacetate and glycerol tributyrate; and epoxy derivative-based plasticizers such as epoxidized soy bean oil.

Examples of the phthalate-based plasticizers include dialkyl phthalate plasticizers such as dibutyl phthalate, dihexyl phthalate, di-2-ethylhexyl phthalate, diisononyl phthalate and diisodecyl phthalate; alkyl benzyl phthalate plasticizers such as butyl benzyl phthalate and myristyl benzyl phthalate; alkyl aryl phthalate plasticizers; dibenzyl phthalate plasticizers; and diaryl phthalate plasticizers.

Examples of the phosphate-based plasticizers include triaryl phosphate plasticizers such as tricresyl phosphate; trialkyl phosphate plasticizers such as trioctyl phosphate; and alkyl aryl phosphate plasticizers.

Among the above plasticizers, phthalate-based plasticizers are preferable from the standpoint of the industrial availability at a low price, the workability and the small toxicity. Among the phthalate-based plasticizers, diisodecyl phthalate, diisononyl phthalate and di-2-ethylhexyl phthalate are preferable. For the high speed printing, diisodecyl phthalate (occasionally referred to as DIDP, hereinafter) is more preferable.

The plasticizer may be used singly or in combination of two or more.

The formation of the ink receiving layer may be conducted by homogeneously dissolving the cellulose ester and the plasticizer described above in prescribed relative amounts in an organic solvent, followed by adjusting the concentration, applying the obtained coating fluid to the intermediate layer disposed on the base material and drying the formed coating layer.

It is preferable that the thickness of the ink receiving layer is in the range of 5 to 50 μm and more preferably in the range of 10 to 40 μm after being dried when the printing is conducted at the standard speed. When the printing is conducted at a high speed, it is preferable that the thickness is in the range of 30 to 70 μm and more preferably in the range of 40 to 60 μm after being dried.

The organic solvent is not particularly limited as long as the cellulose ester and the plasticizer are homogeneously dissolved. Examples of the organic solvent include ketone solvents such as methyl ethyl ketone, ester solvents such as ethyl acetate and aromatic hydrocarbon solvents such as toluene. The concentration of the coating fluid is not particularly limited. The concentration is, in general, about 10 to 30% by weight.

Where necessary, various agents may be added to the coating fluid. Examples of the agent include various types of surfactants, ultraviolet light absorbents, antistatic agents, leveling agents, antioxidants and fillers.

The application of the above coating fluid to the intermediate layer can be conducted using a conventional means such as a film applicator, a gravure roll coater, a reverse roll coater, an air knife coater, a bar coater, a blade coater, a spray coater and a curtain coater.

The condition of drying the applied coating fluid is not particularly limited as long as degradation of the base material, the intermediate layer and the ink receiving layer does not take place.

The material for inkjet recording of the present invention is, in particular, suitable for the formation of a printed image with a pigment-based inkjet ink of the nonaqueous type.

As the medium for the pigment-based ink of the nonaqueous type, glycol ether-based media are preferable. Examples of the glycol ether-based medium include glycol ethers such as diethylene glycol monobutyl ether, triethylene glycol monobutyl ether, monopropylene glycol monobutyl ether, monopropylene glycol monoethyl ether, monopropylene glycol monopropyl ether, monopropylene glycol monomethyl ether, dipropylene glycol monobutyl ether, diethylene glycol monohexyl ether, propylene glycol monoethylene glycol monobutyl ether, propylene glycol diethylene glycol monohexyl ether, ethylene glycol monopropylene glycol monopentyl ether, ethylene glycol dipropylene glycol monobutyl ether and ethylene glycol dipropylene glycol monopentyl ether. The medium may be used singly or in combination of two or more.

Examples of the pigment in the pigment-based ink of the nonaqueous type include inorganic pigments such as titanium oxide, zinc oxide, iron oxide, ultramarine, Prussian blue, carbon black, cobalt blue and chrome yellow; insoluble azo pigments such as anilide-based pigments, acetoacetate anilide bisazo-based pigments and pyrazolone-based pigments; and organic pigments such as copper phthalocyanine blue, quinacridone-based pigments, thioindigo-based pigments and indanthrone-based pigments. The pigment may be used singly or in combination of two or more.

The printing may be conducted using a dye-based ink. Examples of the dye in the dye-based ink include azo dyes, quinoline dyes, anthraquinone dyes, indigo dyes, cyanine dyes, naphthoquinone dyes, phthalocyanine dyes, nitro dyes and metal complex salt dyes.

The binder for the inkjet ink is not particularly limited, and any binder can be selected from conventional binders for the inkjet ink which can be mixed with and dispersed in the above solvent comprising the glycol ether. Examples of the binder for the ink include styrene-acrylic resins, phenolic resins modified with rosin, terpene-based resins, polyester resins, polyamide resins, epoxy resins, vinyl chloride-vinyl acetate copolymer resins and cellulose-based resins. Where necessary, binders comprising various conventional agents such as plasticizers, dispersants, waxes, surfactants, antistatic agents, viscosity adjustment agents, defoaming agents, antioxidants and ultraviolet light absorbents may be used.

Using the material for inkjet recording of the present invention, the printing on the ink receiving layer can be conducted under a conventional condition of inkjet printing with a conventional inkjet ink, preferably a pigment-based inkjet ink, comprising the glycols, the coloring agents such as pigments and dyes, the binder and various additives using a conventional inkjet printer and a conventional plotter. When the high speed printing is conducted, the printing is conducted in a high speed mode or using a printer for the high speed printing.

The laminate having a print of the present invention will be described in the following.

The laminate having a print of the present invention comprises inkjet recorded material (A) which is a material for inkjet recording of the present invention described above and comprises a transparent base material and an ink receiving layer having the print on a face, and member for attachment (B) comprising a support which is laminated to the face having the print of the ink receiving layer of inkjet recorded material (A) via an adhesive layer and has an adhesive layer having a release sheet and disposed on the face opposite to the face attached to inkjet recorded material (A). As the above transparent base material, films and sheets obtained from an acrylic resin as the raw material are preferable since the transparency and the weatherability are excellent, and the effect of the intermediate layer described above can be effectively exhibited.

The adhesives constituting the above adhesive layer disposed on the face having the print (referred to as adhesive layer I, hereinafter) and the adhesive layer attached with a release sheet (referred to as adhesive layer II, hereinafter) are not particularly limited. For example, acrylic adhesives, rubber-based adhesives, silicone-based adhesives and polyurethane-based adhesives can be used. Among these adhesives, acrylic adhesives are preferable from the standpoint of weatherability.

As the acrylic adhesive, adhesives comprising, for example, at least one substance selected from homopolymers of acrylates, copolymers comprising two or more acrylates and copolymers of acrylates and other functional monomers can be used. Examples of the acrylate include butyl(meth)acrylate, pentyl(meth)acrylate, hexyl(meth)acrylate, heptyl(meth)acrylate, octyl(meth)acrylate, nonyl(meth)acrylate and decyl(meth)acrylate. Examples of the functional monomer include monomers having hydroxyl group such as hydroxyethyl(meth)acrylate, hydroxypropyl(meth)acrylate; monomers having amide group such as (meth)acrylamide and dimethyl(meth)acrylamide; and monomers having carboxylic acid group such as (meth)acrylic acid.

Where desired, the adhesive may further comprise crosslinking agents, tackifiers, antioxidants, ultraviolet light absorbents, photostabilizers and fillers. As adhesive layer I, where desired, an adhesive comprising pigments may be used to improve the ability of shielding the printed image. The thickness of adhesive layer I and adhesive layer II is, in general, about 5 to 100 μm and preferably about 10 to 60 μm.

The support having adhesive layer II having a release sheet, which is laminated to the face having the print via adhesive layer I, is not particularly limited. For example, the support can be suitably selected from paper, synthetic paper and plastic sheets. Examples of the paper include wood free paper, art paper, coated paper, craft paper and laminate paper obtained by laminating a thermoplastic resin such as polyethylene to the paper described above.

The synthetic paper is obtained by forming the surface layer into a shape similar to paper using a combination of a thermoplastic resin and inorganic fillers. Examples of the synthetic paper include synthetic papers obtained from polyolefin-based resins, polystyrene-based resins, polyvinyl chloride-based resins and polyester-based resins.

Examples of the plastic sheet include sheets obtained from polyolefin-based resins such as polyethylene, polypropylene and various types of olefin-based copolymers, polyester-based resins such as polyethylene terephthalate and polyethylene naphthalate, polystyrene-based resins, polyvinyl chloride-based resins, acrylic resins, polycarbonate-based resins, polyamide-based resins, fluororesins such as polytetrafluoroethylene and mixtures of these resins; and laminates of these sheets.

The plastic sheet may be transparent or opaque when adhesive layer I comprises pigments and has the function of the shielding layer. When adhesive layer I is transparent, it is preferable that the plastic sheet is opaque with whitish color.

The plastic sheet may have a surface treatment or a primer treatment on one or both faces to improve adhesion with adhesive layer I and adhesive layer II, where desired. As the surface treatment, the treatments described above as the examples of the surface treatment in the description of the base material of the material for inkjet recording can be conducted.

In the present invention, the thickness of the support is, in general, in the range of 10 to 100 μm and preferably in the range of 20 to 70 μm.

Examples of the release sheet attached to adhesive layer II include release sheets obtained by applying a release agent such as a silicone resin to paper base materials such as glassine paper, coated paper and wood free paper, laminate papers obtained by laminating a thermoplastic resin to the paper base materials, and plastic films, examples of which include films of polyesters such as polyethylene terephthalate, polybutylene terephthalate and polyethylene naphthalate and films of polyolefins such as polypropylene and polyethylene. The thickness of the release sheet is not particularly limited. The thickness is, in general, about 20 to 150 μm.

As for the laminate having a print of the present invention, the process shown in the following can be used as the process for laminating the support having adhesive layer II having a release sheet on the face having a print of inkjet recorded material (A) via adhesive layer I.

Adhesive layer I and adhesive layer II are disposed on the faces of the support in accordance with a conventional process. A release sheet is attached to each of the disposed adhesive sheets, and a double sided adhesive sheet having release sheets is prepared. The release sheet at the side of adhesive layer I is removed, and the double sided adhesive sheet having the release sheet on one face is laminated to one face of inkjet recorded material (A) in a manner such that adhesive sheet I is brought into contact with the face having a print of inkjet recorded material (A).

In the laminate having a print of the present invention obtained as described above, where desired, a protective film can be disposed on the face of the base material of inkjet recorded material (A) opposite to the face having the ink receiving layer. The protective film is not particularly limited as long as the protective film has a suitable releasing property from the base material and a mechanical property suitable as the protective film. Examples of the protective film include polyester resin-based films such as polyethylene terephthalate films; and polyolefin-based films such as polyethylene films and polypropylene films. Where necessary, a release layer such as a layer of polyethylene wax may be formed on the face of the protective film at the side attached to the base material of inkjet recorded material (A).

The thickness of the protective film is not particularly limited. The thickness is, in general, about 10 to 150 μm and preferably 20 to 100 μm.

The protective film has the function of preventing formation of damages on the base material of inkjet recorded material (A) when an article attached with a print is attached to an adherend using the laminate having a print of the present invention, as will be described later more specifically. Moreover, the lamination of the protective film to the base material suppresses waving of the base material and strain on the surface which may take place due to the medium of the ink during the printing on the ink receiving layer in accordance with the inkjet recording process.

The process for laminating the protective film is not particularly limited, and various processes can be used. Examples of the process include processes of lamination by forming a coating layer having a prescribed thickness using a film applicator, a gravure coater, a roll knife coater, a reverse coater, a knife coater or a spray coater. In the material for inkjet recording of the present invention, the process sheet described above may work as the protective film.

The laminate having a print of the present invention having the structure described above is used for attaching a print to an adherend. To attach a print using the laminate having a print, the release sheet attached to adhesive layer II in the laminate having a print is removed, and the exposed adhesive layer II is brought into contact with the adherend. Then, inkjet recorded material (A) is pressed at the side of the base material by a squeegee or the like so that the print is attached to the adherend, and an article attached with a print can be obtained. At this time, there is the possibility of formation of damages to the base material when the squeegee is directly pressed to the base material. The possibility of formation of damages can be prevented when a protective film is disposed on the base material as described above, and the squeegee is pressed to the base material via the protective film. When the attachment of the print to the adherend is completed, the protective film is peeled off and removed from the base material.

The present invention provides the process for producing an article attached with a print described above.

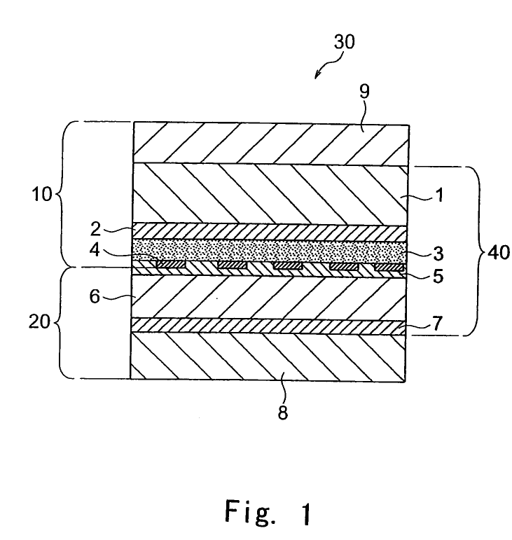

FIG. 1 shows a sectional view of an embodiment of the laminate having a print of the present invention. In a laminate having a print 30, an intermediate layer 2 and an ink receiving layer 3 having a layer having a print on the surface 4 are successively laminated on the face opposite to the face having a protective film 9, which is disposed where necessary. These films and layers constitute inkjet recorded material (A) 10. To the layer having a print 4 of inkjet recorded material (A) 10, a member for attachment 20 having adhesive layer I 5, a support 6 and adhesive layer II 7 having a release sheet 8 is laminated.

To produce an article attached with a print using the laminate having a print 30 having the above structure, the release sheet 8 is removed, and the exposed adhesive layer II 7 is brought into contact with the adherend. The laminate is pressed by a squeegee or the like at the side of the protective film 9, and then the protective film 9 is removed. Thus, an article attached with a print in which a material having a print 40 is attached to the adherend can be obtained.

When the laminate having a print of the present invention is used, a printed image of excellent quality with remarkable clarity exhibiting excellent weatherability and excellent property of fixing the ink can be obtained with suppressed formation of cracks by the printing on the ink receiving layer preferably using a pigment-based ink of the nonaqueous type in accordance with the inkjet recording process. Therefore, the article attached with a print of the present invention having the above printed images of excellent quality can be advantageously used, for example, for indoor and outdoor advertisements, displays and decorations, and more specifically, for outdoor advertisement boards, marking sheets for automobiles, outdoor electrically illuminated advertisement tents and graphic sheets on the surface of acrylic resin plates.

The present invention will be described more specifically with reference to examples in the following. However, the present invention is not limited to the examples.

The properties of materials for inkjet recording obtained in Examples were evaluated in accordance with the following methods.

(1) Presence or Absence of Cracks in a Printed Image (in the Case of the Standard Speed Printing)

The quality of a recorded image was evaluated by visual observation and classified into the following three classes:
good: No crack found on the portion of the solid printing
fair: Some cracks found on the portion of the solid printing
poor: Many cracks found on the portion of the solid printing
   (2) Property of Drying the Ink (in the Case of the Standard Speed Printing)

A recorded image was slightly rubbed by a finger 10 minutes after the printing, and the change in the image was evaluated by visual observation and classified into the following three classes:
good: No change
fair: Ink transferred to the finger, but no change in the image itself
poor: Ink transferred to the finger, and damages on the image by rubbing
   (3) Presence or Absence of Cracks in a Printed Image (in the Case of the High Speed Printing)

The quality of a recorded image was evaluated by visual observation and classified into the following four classes:
excellent: No crack found on the portion of the solid printing
good: Minute cracks found slightly on the portion of the solid printing, but no problem on the practical application
fair: Some cracks found on the portion of the solid printing poor: Many cracks found on the portion of the solid printing

### EXAMPLE 1

Components of a coating fluid shown in the following were mixed and dispersed using a disper at 1,400 rpm for 15 minutes, and a coating fluid for a base material was prepared.

An acrylic resin (a methyl methacrylate/styrene/butyl acrylate copolymer; the ratio of the amounts of the monomer units: 90/8/2): 100 parts by weight

Methyl ethyl ketone (MEK): 200 parts by weight

N,N-Dimethylformamide (DMF): 100 parts by weight

An ultraviolet light absorbent [manufactured by ASAHI DENKA Co., Ltd.; “ADEKASTAB 1413”]: 1 part by weight

A polyester-based plasticizer [manufactured by DAINIPPON INK AND CHEMICALS, Inc.; “MONOCIZER W-260”]: 5 parts by weight

A coloring agent: 10 parts by weight

The coating fluid for a base material prepared above was applied to a polyethylene terephthalate film having a thickness of 50 μm [manufactured by TEIJIN DU PONT FILMS JAPAN, Ltd.; “GII-50”] as the process sheet using a film applicator in an amount such that the dried coating film had a thickness of 50 μm, and a base material was formed. The formed base material was coated with a mixture of polyvinyl chloride and an acrylic resin in relative amounts by weight of 1:1 (manufactured by DAINICHISEIKA COLOR & CHEMICALS MFG. Co., Ltd.; an agent for the surface treatment; “LEATHERHIT LG-325 (KAI)”] as the intermediate layer using a bar coater in an amount such that the dried coating film had a thickness of 5 μm. A coating fluid for the ink receiving layer was prepared by sufficiently dispersing and dissolving 100 parts by weight of a cellulose ester [manufactured by EASTMAN CHEMICAL Ltd.; “CAB-381-2”; the number average molecular weight: 40,000; the degree of acetylation: 13.5% by mole; the degree of butyrylation: 38.0% by mole; the content of hydroxyl group: 1.3% by weight; the glass transition temperature: 133° C.] and 40 parts by weight of diisodecyl phthalate as the plasticizer into 200 parts by weight of MEK and 100 parts by weight of DMF. The prepared coating fluid was applied to the intermediate layer formed above using an applicator in an amount such that the dried coating film had a thickness of 25 μm, and a film for inkjet recording was obtained.

Full color solid printing of four colors, i.e., cyan, magenta, yellow and black, were conducted on the ink receiving layer of the film for inkjet recording obtained above at the standard speed using a commercial inkjet printer [manufactured by ROLAND DG Corporation; “SOLJET SC-500”] and a pigment-based ink in which pigments were dispersed in a nonaqueous solvent containing a glycol ether as the main component [“SOLINK”], and the presence or absence of cracks and the property of quick drying were evaluated. The results are shown in Table 1.

### EXAMPLE 2

A film for inkjet recording was obtained in accordance with the same procedures as those conducted in Example 1 except that a cellulose ester [manufactured by EASTMAN CHEMICAL Ltd.; “CAB-381-0.5”; the number average molecular weight: 30,000; the degree of acetylation: 13.5% by mole; the degree of butyrylation: 38.0% by mole; the content of hydroxyl group: 1.3% by weight; the glass transition temperature: 130° C.) was used in place of the cellulose ester [manufactured by EASTMAN CHEMICAL Ltd.; “CAB-381-2”]. The obtained film was evaluated in accordance with the same procedures as those conducted in Example 1. The results are shown in Table 1.

### EXAMPLE 3

A film for inkjet recording was obtained in accordance with the same procedures as those conducted in Example 1 except that diisononyl phthalate was used in place of diisodecyl phthalate. The obtained film was evaluated in accordance with the same procedures as those conducted in Example 1. The results are shown in Table 1.

### EXAMPLE 4

A film for inkjet recording was obtained in accordance with the same procedures as those conducted in Example 1 except that a mixture of polyvinyl chloride and an acrylic resin in relative amounts by weight of 1:2.7 was used for the intermediate layer in place of the mixture of polyvinyl chloride and an acrylic resin in relative amounts by weight of 1:1 [“LEATHERHIT LG-325 (KAI)”]. The obtained film was evaluated in accordance with the same procedures as those conducted in Example 1. The results are shown in Table 1.

### COMPARATIVE EXAMPLE 1

A film for inkjet recording was obtained in accordance with the same procedures as those conducted in Example 1 except that an agent for the surface treatment made of 100% of an acrylic resin [“LEATHERHIT LG961”] was used for the intermediate layer in place of the mixture of polyvinyl chloride and an acrylic resin in relative amounts by weight of 1:1 [“LEATHERHIT LG-325 (KAI)”]. The obtained film was evaluated in accordance with the same procedures as those conducted in Example 1. The results are shown in Table 1.

### COMPARATIVE EXAMPLE 2

A coating fluid for the ink receiving layer was prepared by sufficiently dispersing and dissolving 100 parts by weight of a cellulose ester [manufactured by EASTMAN CHEMICAL Ltd.; “CAB-381-2”] and 5 parts by weight of diisodecyl phthalate into 200 parts by weight of MEK and 100 parts by weight of DMF. A film for inkjet recording was obtained in accordance with the same procedures as those conducted in Example 1 except that the prepared coating fluid was applied by a film applicator in an amount such that the dried coating film had a thickness of 25 μm. The obtained film was evaluated in accordance with the same procedures as those conducted in Example 1. The results are shown in Table 1.

### COMPARATIVE EXAMPLE 3

A film for inkjet recording was obtained in accordance with the same procedures as those conducted in Example 1 except that the intermediate layer was not formed on the base material. The obtained film was evaluated in accordance with the same procedures as those conducted in Example 1. The results are shown in Table 1.

TABLE 1

| | Presence or absence of cracks | Property of |
|---|---|---|
| | in portion of solid printing | drying ink |
| Example 1 | good | good |
| Example 2 | good | good |
| Example 3 | good | good |
| Example 4 | good | good |
| Comparative Example 1 | fair | fair |
| Comparative Example 2 | fair | fair |
| Comparative Example 3 | poor | good |

It is shown by the results in Table 1 that cracks were formed in the printed image when the intermediate layer was not formed (Comparative Example 3). Even when the intermediate layer was formed, cracks were formed in the printed image and the property of drying the ink was insufficient when the intermediate layer was formed with 100% acrylic resin (Comparative Example 1). Cracks were formed in the printed image and the property of drying the ink was insufficient when the amount of the plasticizer contained in the ink receiving layer was less than the range specified in the present invention (Comparative Example 2).

In contrast, it is shown that no crack was formed and the property of drying the ink was excellent in the printing at the standard speed when the intermediate layer was formed with the vinyl halide resin or the vinyl halide/(meth)acrylate copolymer resin, and the ink receiving layer contained the plasticizer in an amount of 10 parts by weight or more per 100 parts by weight of the cellulose ester (Examples 1 to 4).

### EXAMPLE 5

A coating fluid for the ink receiving layer was prepared by sufficiently dispersing and dissolving 100 parts by weight of a cellulose ester [manufactured by EASTMAN CHEMICAL Ltd.; “CAB-381-2”] and 50 parts by weight of diisodecyl phthalate into 200 parts by weight of MEK and 100 parts by weight of DMF. A film for inkjet recording was obtained in accordance with the same procedures as those conducted in Example 1 except that the prepared coating fluid was applied by a film applicator in an amount such that the dried coating film had a thickness of 50 μm.

Full color solid printing of four colors, i.e., cyan, magenta, yellow and black, were conducted on the ink receiving layer of the film for inkjet recording obtained above at a high speed under the high speed mode (a speed twice as much as that of the standard mode) using a commercial inkjet printer [“SOLJET SC-500”] and the ink described above [“SOLINK”], and an inkjet recorded material was prepared. The presence or absence of cracks in the printed image was examined. The result is shown in Table 2.

### EXAMPLE 6

A coating fluid for the ink receiving layer was prepared by sufficiently dispersing and dissolving 100 parts by weight of a cellulose ester [manufactured by EASTMAN CHEMICAL Ltd.; “CAB-381-2”] and 60 parts by weight of diisodecyl phthalate into 200 parts by weight of MEK and 100 parts by weight of DMF. A film for inkjet recording was obtained in accordance with the same procedures as those conducted in Example 1 except that the prepared coating fluid was applied by a film applicator in an amount such that the dried coating film had a thickness of 50 μm.

The obtained film was evaluated in accordance with the same procedures as those conducted in Example 5. The result is shown in Table 2.

### EXAMPLE 7

Printing was conducted in accordance with the same procedures as those conducted in Example 5 using the same film for inkjet recording as that used in Example 1 to prepare a material for inkjet recording, and the presence or absence of cracks in the printed image was examined. The result is shown in Table 2.

### EXAMPLE 8

A coating fluid for the ink receiving layer was prepared by sufficiently dispersing and dissolving 100 parts by weight of a cellulose ester [manufactured by EASTMAN CHEMICAL Ltd.; “CAB-381-2”] and 40 parts by weight of diisodecyl phthalate into 200 parts by weight of MEK and 100 parts by weight of DMF. A film for inkjet recording was obtained in accordance with the same procedures as those conducted in Example 1 except that the prepared coating fluid was applied by a film applicator in an amount such that the dried coating film had a thickness of 50 μm.

The obtained film was evaluated in accordance with the same procedures as those conducted in Example 5. The result is shown in Table 2.

### EXAMPLE 9

A coating fluid for the ink receiving layer was prepared by sufficiently dispersing and dissolving 100 parts by weight of a cellulose ester [manufactured by EASTMAN CHEMICAL Ltd.; “CAB-381-2”] and 60 parts by weight of diisodecyl phthalate into 200 parts by weight of MEK and 100 parts by weight of DMF. A film for inkjet recording was obtained in accordance with the same procedures as those conducted in Example 1 except that the prepared coating fluid was applied by a film applicator in an amount such that the dried coating film had a thickness of 25 μm.

The obtained film was evaluated in accordance with the same procedures as those conducted in Example 5. The result is shown in Table 2.

TABLE 2

| | Presence or absence of cracks in printed portion |
|---|---|
| Example 5 | excellent |
| Example 6 | excellent |
| Example 7 | good |
| Example 8 | good |
| Example 9 | good |

It is shown by the results in Table 2 that no crack was formed in the portion of the solid printing even in the high speed printing in Examples 5 and 6 in which the material for inkjet recording of the present invention was used under the condition of high speed printing.

### EXAMPLES 10 to 15

Using a double sided adhesive sheet for mounting (manufactured by LINTEC Corporation.; “LAG MOUNT MOTHER CLEAN A-3532W”: the support: a white acrylic film having a thickness of 25 μm; an acrylic adhesive layer having a thickness of 30 μm and containing pigments was disposed on one face; an acrylic adhesive layer having a thickness of 25 μm was disposed on the other face), the release sheet at the side having the adhesive layer containing pigments was removed, and the adhesive layer containing pigments was exposed.

The materials for inkjet recording obtained in Examples 1 to 6 and having a print on the ink receiving layer of the film for inkjet recording were each attached to the above double sided adhesive sheet in a manner such that the face having a print is brought into contact with the adhesive layer containing pigments, and laminates having a print were prepared.

The release sheet in each laminate having a print prepared above was removed to expose the adhesive layer, and the exposed adhesive layer was brought into contact with an acrylic resin plate. The obtained laminate was pressed by a squeegee over the protective film, and the protective film on each laminate was removed. Thus, articles attached with a print, in which the print was attached to the acrylic plate, were prepared.

The articles attached with a print obtained in Examples 10 to 15 had printed images of excellent quality and exhibited great commercial values.

### INDUSTRIAL APPLICABILITY

The material for inkjet recording of the present invention can be printed by the inkjet recording method using a pigment-based ink of the nonaqueous type obtained by dispersing pigments in a nonaqueous medium containing a glycol ether as the main component, exhibits excellent properties of drying, fixing and printing the ink and excellent weatherability and provides a printed image of excellent quality with remarkable clarity without formation of cracks.

The laminate having a print of the present invention has a printed image of excellent quality exhibiting excellent clarity, weatherability and property of fixing the ink with suppressed formation of cracks which can be formed by the printing using a pigment-based ink of the nonaqueous type in accordance with the inkjet recording process, and can be advantageously used for preparing an article attached with a print such as indoor and outdoor advertisements, displays and decorations.

1. A material for inkjet recording which comprises a base material, an intermediate layer comprising at least one of a vinyl halide resin and/or a vinyl halide/(meth)acrylate copolymer resin and an ink receiving layer comprising a cellulose ester and 10 to 100 parts by weight of a plasticizer per 100 parts by weight of the cellulose ester, the intermediate layer and the ink receiving layer being disposed successively on one face of the base material.

2. A material for inkjet recording according to claim 1, wherein the cellulose ester in the ink receiving layer is at least one substance selected from cellulose acetate butyrate, cellulose acetate propionate and cellulose acetate.

3. A material for inkjet recording according to claim 1, wherein the plasticizer in the ink receiving layer is a phthalate-based plasticizer.

4. A material for inkjet recording according to claim 1, wherein the base material is a base material comprising an acrylic resin as a raw material.

5. A material for inkjet recording according to claim 1, wherein a thickness of the ink receiving layer is 5 to 70 μm.

6. A material for inkjet recording according to claim 1, wherein a content of the plasticizer in the ink receiving layer is 20 to 80 parts by weight per 100 parts by weight of the cellulose ester.

7. A laminate having a print which comprises inkjet recorded material (A) which is a material for inkjet recording described in claim 1 and comprises a transparent base material and an ink receiving layer having the print on a face, and member for attachment (B) comprising a support which is laminated to the face having the print of the ink receiving layer of inkjet recorded material (A) via an adhesive layer and has an adhesive layer having a release sheet and disposed on a face opposite to the face attached to inkjet recorded material (A).

8. A laminate having a print according to claim 7, wherein the support in member for attachment (B) is a support obtained from an acrylic resin as a raw material.

9. A laminate having a print according to claim 7 wherein inkjet recorded material (A) comprises a protective film disposed on a face of the base material opposite to a face having the ink receiving layer.

10. A process for producing an article attached with a print, which comprises removing a release sheet from a laminate having a print described in claim 7, bringing an exposed adhesive layer into contact with an adherend, and pressing the laminate having a print at a side of the base material of inkjet recorded material (A) so that the print on the laminate is attached to the adherend.

11. A process for producing an article attached with a print, which comprises removing a release sheet from a laminate having a print described in claim 9, bringing an exposed adhesive layer into contact with an adherend, pressing the laminate having a print at a side of the protective film so that the print on the laminate is attached to the adherend, and removing the protective film.
